(19) United States
(12) Patent Application Publication
(10) Pub. No.: US 2012/0210760 A1
(43) Pub. Date: Aug. 23, 2012

(54) PHOSPHORUS-FREE OR LOW PHOSPHORUS FERTILIZER

(75) Inventor: Roger Funk, Garrettsville, OH (US)

(73) Assignee: THE DAVEY TREE EXPERT COMPANY, Kent, OH (US)

(21) Appl. No.: 13/400,741

(22) Filed: Feb. 21, 2012

Related U.S. Application Data
(60) Provisional application No. 61/444,930, filed on Feb. 21, 2011.

(51) Int. Cl. C05C 9/02; C05B 17/00

(52) U.S. Cl. 71/28; 71/27

(57) ABSTRACT

Phosphorus-free or low phosphorus fertilizer compositions containing a polyamino acid salt. The fertilizer formulations disclosed herein contain a nitrogen source, a potassium source, a polyamino acid salt and in some cases a low level source of phosphorus. The compositions may be in the form dry homogeneous blends and may be carried in liquid for application to surface or subsurface areas by conventional liquid fertilizer applying equipment.

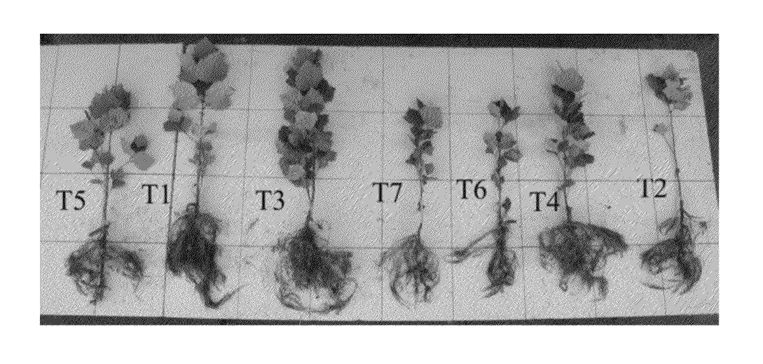

### CROSS REFERENCE TO RELATED APPLICATION

The present application claims the benefit of U.S. Provisional Application No. 61/444,930 filed on Feb. 21, 2011, the contents of which are hereby incorporated by reference.

### BACKGROUND

The present application relates generally to fertilizer compositions and particularly to formulations that contain a polyamino acid salt and are substantially phosphorus-free. The fertilizers may be mixtures of synthetic organic and inorganic materials in the form of dry homogeneous, low burn, high analysis fertilizers which may be carried in liquid for application in surface and subsurface spraying and injection fertilization.

Nitrogen, phosphorus and potassium are considered the primary macronutrients for plant growth and their percent by weight is required by law to be stated on a fertilizer bag, known as the “grade” or “analysis”. These three elements are absorbed from the soil in larger amounts by plants than any of the other approximately 14 elements required for plant growth and development. A fertilizer that contains all of the primary macronutrients—nitrogen, phosphorus and potassium—is called a “complete” fertilizer and is commonly used to supplement the nutrients found naturally in the soil to promote woody plant growth in the landscape. However, because phosphorus can erode into waterways under certain soil and site conditions, state and local governments are initiating or considering regulations restricting the amount of phosphorus that can be applied, particularly in riparian areas.

According to recent test results, 40% of landscape soil is considered to be below “good” or adequate levels of phosphorus for woody plant growth. In addition, much of the phosphorus in the soil is fixed, that is, unavailable for plant uptake. As little as 0.01% of soil phosphorus is in an ionic form (i.e., H₂PO₄⁻) that plants can absorb.

Yet phosphorus is essential for meristematic cell growth, which makes it critically important for root development because of the numerous root tips that depend upon cell division to expand into new areas of the soil for water and nutrient uptake. Fertilizers without phosphorus or insufficient amounts often elicit little if any root development in woody plants. This can be detrimental to the long term health of perennial plants such as trees and shrubs that must maintain an equilibrium between the roots and shoots to survive drought, temperature extremes and pests.

A fertilizer is needed for woody plants that does not contain phosphorus but will duplicate the root effect of phosphorus-containing fertilizer for riparian areas or other situations where the addition of phosphorus is not advisable.

When caring for trees or other plants it is important to provide proper fertilization to maintain plant health. Fertilization is particularly important for trees since they are commonly planted in landscape soils with poor structure and fertility and the primary source of nutrients, leaf litter, is usually removed. In addition, turfgrass is often planted over the root area of trees, which compete with tree roots for the growth factors absorbed from soil. Phosphorus is particularly important since it is critical for growth of root meristems but less than 0.01% of the phosphorus inherent in the soil is typically in a form available to plants. Thus, phosphorus typically is an important component of a complete fertilizer for landscape trees.

Phosphorus, however, can erode or wash into water sources resulting in eutrophication of lakes and rivers. Some state or local governments are initiating or considering regulations to limit or restrict the amount of phosphorus that can be applied to landscape plants, particularly in riparian areas. Since phosphorus is considered to be an essential nutrient for plant growth, development and reproduction, the elimination of phosphorus from fertilizer compositions would be expected to adversely affect plant growth and development. The present application addresses the need for a fertilizer that provides the benefits of a complete fertilizer while eliminating or significantly reducing the amount of phosphorus in the composition.

The use of fertilizer blends of both organic and inorganic material has become recognized as being advantageous in many fertilizer applications. Such blends not only supply nutrients which may be immediately absorbed into the plant root system, but also provide a source of long-term nutrient supply.

In order for any nutrient material to be absorbed by a plant root system, it must be dissolved to create various ion structures or salts which are readily attracted and absorbed into the root tissue by an ion exchange process. The conventional inorganic fertilizer material which may include phosphates and potassium is soluble in water and forms ions readily when dissolved. Therefore when such fertilizers are supplied to the soil in liquid form, the nutrient ions or salts are immediately available for absorption, or, if dry inorganic fertilizers are used, the nutrient ions or salts become available as water is percolated through the soil.

Various organic fertilizers, those structures which include animal, vegetable and synthetic carbon structures, on the other hand, are advantageous in that they exhibit slower rates of decomposition. That is, organic fertilizer material ordinarily is not readily soluble in water, but only breaks down by microorganism action in the soil to release nutrient ions over a period of time and thus a single fertilizer application may supply nutrients for an extended period. Such organic materials are often referred to as controlled release or slow release fertilizers.

As mentioned above, organic and inorganic fertilizers may be supplied in either soluble or insoluble form and may either be spread or sprayed onto surface areas or injected or otherwise supplied to subsurface areas. However, when using readily soluble fertilizers, one is limited to the amount of nutrients which may be effectively supplied to the soil without causing damage to plant tissues, a problem commonly referred to as plant or root burn. As the nutrients of the soluble fertilizer are readily dissolved for plant absorption, an excessive amount of salt concentration due to the number of ions released adjacent the root system, may suppress the water absorption by the roots and in some cases may extract moisture from the plant causing the plant to be subjected to a moisture deficiency. However, various fertilizer nutrients are less likely to cause root burn even when in a soluble state. Generally, the potential for causing root burn is determined by the salt index of the particular nutrient, as the greater the salt index, the greater the ion concentration in the soil. Often fertilizers contain significant quantities of high salt index ingredients which, although containing necessary nutrients, may be harmful if supplied in excessive quantities.

Insoluble fertilizers, on the other hand, must be broken down by either chemical or biodegradable action and thus the rate of salt supply may be reduced somewhat depending upon climatic and soil conditions. Also, many insoluble fertilizers having particulate material of a size to be readily blended with soluble material are generally not readily adaptable to the presently increasing use of pressure or hydraulic fertilizer injection techniques since the particle sizes of the insoluble material are not small enough to allow the fertilizer material to be injected through small-bore nozzles. In addition, soluble fertilizers readily disperse throughout the root zone with hydraulic soil injection. However, insoluble fertilizer must be ground to a particulate size small enough that it is not filtered out by the soil particles, much like sand filters out insoluble particles in a swimming pool. Otherwise, the fertilizer remains at the injection site, limiting root contact. This is particularly important with phosphorus, which is immobile or fixed in most soils.

The possibility of root burn is further increased if high analysis fertilizers are used since a greater concentration of available nutrient ions are present. High analysis fertilizer compositions are generally viewed as those in which the total percent of the nitrogen is equal to or exceeds 20% of the overall fertilizer weight and the total percent of the nitrogen, potassium and phosphate nutrients is at least 40% of the fertilizer weight.

The use of high analysis fertilizers is often desirable for several reasons. Not only will the nutrients be supplied to the consumer in less bulk, but the amount of nutrients applied per surface or subsurface applications may be significantly increased. Again, however, as the concentration of nutrient ions is increased, the danger of root burn also increases.

In addition to their burn potential, all nutrient salts or ions are subject to leaching as water dissolves minute quantities of the fertilizer material. Such dissolved material usually moves with the water and leaches away from the area of the roots. However, all nutrients do not leach to the same degree. As an example, nitrate salts (the form of nitrogen primarily absorbed by plant roots) move with ground water and rapidly leach from the root zone while potassium is moderately leached and only a trace of phosphorus is lost. Therefore, in order to insure that a source of nitrogen is maintained in the soil, an insoluble nitrogen could be used to reduce ion loss due to leaching.

Subsurface application of fertilizers is recognized as being a highly desirable method by which to provide for the efficient and effective feeding and caring of trees, shrubs and lawns by supplying nutrients directly to the area of the plant roots. Such application has the added advantage, over surface fertilizing, of decreasing the amount of fertilizer runoff or leaching caused by the action of surface waters.

In this regard, there are generally two widely accepted methods by which fertilizers may be supplied to subsurface areas. These methods include subsurface treatment with a dry fertilizer using drill or vertical hole application techniques, and the subsurface injection of a liquid type fertilizer using injection apparatus.

There are, however, particular problems associated with the subsurface application of fertilizers in either dry or liquid form, especially when considering possible plant damage, economics and labor requirements. Thus, the objective of any fertilization process is the application to the soil of an optimum quantity of various macro and/or micro nutrients to insure the proper ratio and amounts of nutrient ions necessary for plant growth and nourishment in such a manner that expenses and application time are maintained at a minimum.

Liquid injection usually is desirable over dry vertical hole methods because a subsurface application of fertilizer may be made in less time and therefore at a significant reduction in total man hours. Also, the liquid injection technique disperses nutrients throughout the root area increasing root contact and, thus, absorption by the plant. Dry fertilizer in vertical holes does not disperse laterally, providing only “spot” treatments of supplemental nutrients. However, most liquid fertilizers utilize soluble nutrients which if applied at the recommended nutrient level would cause root burn as an excessive amount of ions would be present in the soil immediately after the application, thereby leading to the depletion of the root water supply, as previously discussed. In practice, therefore, liquid injection techniques have necessitated a reduction in the amount of available nutrients supplied per application. For example, if the optimum quantity of a fertilizer nutrient supply is 6 lbs. of nitrogen per 1,000 square feet of root area per year, in practice approximately ½ to 2 lbs. per 1,000 square feet could be applied without fear of damage due to the possible plant or root burn which would be caused if all the nutrients were available in a soluble form.

Vertical hole applications of dry fertilizers, on the other hand, permit the use of the generally insoluble or less soluble particulate material. Currently, many dry type fertilizers contain a combination of readily available inorganic and organic nutrients and slow release long chain organic nutrients. If a fertilizer includes a long chain synthetic organic nitrogen supply, the nitrogen is released only after the carbon chain is slowly broken down by chemical and biological reaction as water seeps through the soil. Thus, with a dry fertilizer, the total nutrient supply may be applied in a single application with a significant reduction in the immediately available nutrient ions thereby reducing the possibility of plant or root burn. However, the time and cost of labor to apply dry fertilizer is greater than that of using liquid injection techniques. This is because holes must be bored or drilled around each plant to be fertilized.

Therefore, although subsurface applications of dry fertilizers are advantageous in permitting an increased nutrient supply by way of slow release nitrogen components to reduce burn potential, pressure or hydraulic injection of fertilizers is often preferred as it is a quicker and easier method by which fertilizer may be applied to subsurface areas without the extra work necessitated by more traditional drill or bore hole techniques. Hydraulic injection is also the best method for nutrient dispersal throughout the root zone.

To obtain the joint benefit of liquid injection together with short and long term nutrient release of some dry fertilizers, it is important to provide a mixture of organic and inorganic fertilizer material which, when mixed with water, forms a solution of the inorganic material and a portion of the organic material and forms a suspension of the remainder of the organic material. Normally a dry inorganic material is supplied in granular or pellet form. However, since such material dissolves readily in water, it does not clog hydraulic equipment. On the other hand, granular or pellet sized particles of some insoluble organic material are not suitable for use with hydraulic injection equipment, as the particles do not pass through the openings in conventional subsurface injection equipment. The problem is in providing a uniform blend of dry soluble and insoluble organic and soluble inorganic fertilizer components which can be injected to subsurface areas when in the presence of a liquid carrier.

Further, in mixing dry synthetic organic material such as ureaformaldehyde, or ureaform, as the requisite particle size is decreased, the more the material exhibits an ability to “flow” because of its low bulk density. That is, as the powdery organic particles are mixed with various inorganic materials in granular or pellet form, they tend to readily separate or settle through the mixture and thus the overall blend is not homogeneous or uniformly mixed. Various prior art methods for effectively dry blending insoluble organic material such as ureaform with soluble inorganic materials have necessitated that the insoluble particle size be approximately the same size as the soluble particles and therefore the insoluble material is not suitable for subsurface injection.

Therefore, to provide the market or consumer with a fertilizer having water soluble inorganic material with very fine particulate water insoluble organic material uniformly suspended therein which could be used for subsurface applications, it typically has been necessary to blend the organic and inorganic material in a solution. By wet mixing, the problem associated with dry blending may be avoided, however, shipping, packaging, consumer handling and other such problems are increased due to the necessity that the fertilizer could only be available as a liquid or slurry. Therefore, it would be desirable to dry blend the materials to reduce shipping, packaging and other such costs.

### SUMMARY

The present invention relates to phosphorus-free or low phosphorus fertilizer compositions containing a polyamino acid salt. The polyamino acid salt compensates for the low levels or absence of phosphorus in the fertilizer composition. Moreover, the inclusion of an amino acid salt enhances the effect of nutrients both in fertilizers and in the soil. The inclusion of amino acid salts can also increase root branching and root hair development. Moreover, amino acid salts can directly or indirectly influence the physiological activities of the plant. For example, the application of amino acid salts before, during and after stress conditions such as high temperatures, drought and pest attack, can help ameliorate stress physiology, thus having a preventing and recovering effect even in the absence of supplemental phosphorus.

In accordance with one aspect of the present invention, a phosphorus-free or low phosphorus fertilizer blend containing a salt of a polyamino acid is provided. In accordance with particular embodiments, the blends may contain a powdered synthetic organic fertilizer material which is of a size to pass at least a 40-mesh sieve and which has an approximate ratio in the range of 3:1 to 1:1 of water insoluble to water soluble nitrogen releasing nutrients and combined with a water soluble potassium source to form fertilizers having ratios of nitrogen and potassium of approximately 2 to 5 parts nitrogen to 1 part of potassium.

In accordance with one aspect of the invention, dry homogeneous high analysis fertilizer blends are provided which contain the nutrients N and K as supplied by the combination of an organic fertilizer such as ureaformaldehyde which has a large percentage of its available nitrogen in a slow release form, an inorganic, water soluble, low salt index fertilizer providing a source of potassium and a salt of a polyamino acid which may be handled and shipped as dry materials but which may be mixed with water for use with conventional fertilizer injection and spraying equipment.

In accordance with certain aspects of the invention, high analysis fertilizers are described having both slow release, generally insoluble, and fast release, generally soluble, nitrogen supply in an optimum ratio of about 2:1 respectively which may be applied to subsurface areas.

High analysis fertilizers in accordance with another aspect of the invention contain both organic materials having a substantial amount of nitrogen available in a slow release or generally water insoluble form, inorganic materials having a low fertilizer salt index factor and a salt of a polyamino acid so that an increased amount of nutrients may be supplied per application while avoiding the possibility of “burn” damage to plant life.

High analysis fertilizers containing a salt of a polyamino acid and having an approximate ideal ratio of about 3:1 of nitrogen and potassium which can be applied by liquid injection techniques without causing root or plant burn are also described.

Dry fertilizers in accordance with particular aspects of the invention are capable of being mixed with water for use in subsurface injection to provide localized short and long term nutrients to plant root areas.

The present application also discloses long term fertilizers in which the total nutrients available in a single fertilizing application are available over an extended period of time. The fertilizers described herein are particularly useful for promoting health and vigor of woody perennials.

### BRIEF DESCRIPTION OF THE DRAWING

The FIGURE is a picture showing the effects of various fertilizer treatments on sycamore trees.

### DETAILED DESCRIPTION

In accordance with the present invention, a fertilizer composition is provided containing a nitrogen source, a potassium source and a salt of a polyamino acid. In accordance with certain embodiments, fertilizer compositions are disclosed that contain synthetic, organic and inorganic materials and, in particular, ureaformaldehyde, potassium sulfate and potassium polyaspartate. The inclusion of a polyamino acid salt in the fertilizer composition has been found to significantly improve plant performance even when the fertilizer contains little, if any, phosphorus.

Fertilizer compositions described herein are described as being phosphorus-free or low phosphorus. In accordance with certain embodiments, the fertilizer compositions may contain no more than 3% P, 2% P or 1% P and be considered as a low phosphorus composition. As used herein, the term “substantially free of phosphorus” mean that the composition contains no more than 0.5% P (P₂O₅ equivalent). The term “phosphorus-free” means that the composition contains no phosphorus or an insignificant amount of phosphorus as a soil nutrient.

Fertilizer compositions in accordance with certain aspects of the present invention typically include between about 0.25% and 2.5% by weight of the polyamino acid salt and, in accordance with particular embodiments of the invention, the fertilizer composition may contain between about 0.3% to 1.0% polyamino acid salt. Examples of polyamino acid salts, useful in accordance with certain aspects of the present invention, as well as and methods of making these salts, are described in U.S. Pat. Nos. 5,814,582; 5,861,356; 5,593,947 and 5,935,909, the disclosures of which are hereby incorporated by reference. A particularly useful polyamino acid salt is the potassium salt of polyaspartic acid (potassium polyaspartate (PPA)). Other polyamino acid salts such as salts of polyglutamic acid, polyglycine acid as well as co-polymers and mixtures thereof may also be used in accordance with the present invention.

Potassium polyaspartate has a very high cation exchange capacity (CEC). CEC provides an indication of how well the soil or soil additive attracts, retains, and exchanges cation elements. A relatively high CEC value is desirable because the presence of negative charges can attract soil particles to form aggregates, which improves the soil structure. Furthermore, the negative charges can attract and retain mineral nutrients and water. Potassium polyaspartate has a CEC of about 720-750 meq/100 g. By comparison, typical landscape soil has a CEC of about 14-20 meq/100 g and humus has a CEC of about 150-200 meq/100 g.

As previously discussed, high analysis fertilizers are desirable to minimize handling and storage problems by reducing the bulk weight of a fertilizer in that a more concentrated source of nutrients may be supplied per unit weight of material. The problem, however, is that the concentrated nutrient sources increase the possibility of root burn. Therefore, in order to develop an acceptable high analysis fertilizer in which the necessary amounts of nutrients may be supplied for a particular application, the final fertilizer composition should be free of high salt index nutrient sources, or if such sources are present, they should be generally insoluble so as to be slowly released over a period of time.

One of the more widely used or common sources of organic fertilizer material has been the synthetically manufactured product which contains amounts of nitrogen in both water soluble and water insoluble form. Ureaformaldehyde or ureaform is one such fertilizer. This water insoluble nitrogen source is advantageous for use in what may be considered slow release or long term fertilizing. That is, the insoluble nitrogen or components of the ureaformaldehyde form a suspension and not a solution when mixed with water and the nutrient value is therefore not immediately released or made available to plant life upon the application of the fertilizer to soil surfaces or subsurfaces.

The ureaformaldehyde is a mixture of unreacted and methylene ureas. The unreacted ureas are soluble in water and provide a relatively quick release source of nitrogen as compared to the slower release nitrogen of methylene ureas. The difference in the rate of nitrogen release is due to the fact that the methylene ureas are relatively long chain polymers which require bacterial decomposition to break down their structure and release the nitrogen while the short chain unreacted urea is immediately available. The nitrogen salts available from urea, however, have generally high salt indexes and if present in too great a concentration will tend to cause root burn. Furthermore, ureaformaldehyde is believed to be the only slow release nitrogen fertilizer that can be pulverized to a 40 mesh particulate size and retain its slow release qualities. Isobutylidene diurea (IBDU) is a similar synthetic organic, but it releases via the action of water and, thus, its release is affected by the surface to volume ratio.

The counterions of the polyamino acid salts include, but are not limited to, alkali metals and alkaline earth metals, specifically sodium, potassium, magnesium, calcium, strontium and ammonium cations. Although sodium salts could possibly be used, sodium is not a plant nutrient and is toxic to plants in relatively low concentrations. Sodium also competes in plant roots for the same absorptive sites as calcium, which is an essential nutrient for plants, and can result in calcium deficiency. In addition, sodium can replace calcium on clay micelles, causing soil to lose its structure and compact. Potassium, on the other hand, is an essential plant nutrient and does not have the negative effects of sodium. Accordingly, the potassium salts of polyamino acids have been found to be effective as nutrient enhancers. In particular, the potassium polyaspartate is particularly useful in accordance with certain aspects of the present invention. Potassium polyaspartate also contributes potassium to the fertilizer and is 10% K₂O equivalent. An additional benefit associated with the use of the potassium salt is that it provides a lower salt index than sodium. Fertilizer compositions in accordance with certain aspects of the present invention have a salt index of less than 10.

In order to develop a high analysis, low burn fertilizer which provides an initial nitrogen release, as well as one which provides for extended nitrogen supply, a ureaformaldehyde is selected which supplies between one-half to three-quarters of its available nitrogen in a slow release form and from between one-quarter to one-half as unreacted urea for immediate absorption. Therefore, the slow to fast release nitrogen ratio which is determined by the ratio of methylene ureas to unreacted ureas, should range between 1:1 to 3:1, respectively. The presence of a large percentage of slow release nitrogen insures that the nitrogen salts will not be overly concentrated in the soil at the time of application but will be made available for plant absorption over a period of time. Additionally, the large percentage of slow release nitrogen insures that the nitrogen source does not leach away from the plant roots in a short time.

Although the ratio of slow to fast release nitrogen may vary somewhat, a preferred ureaformaldehyde is selected which supplies most of its available nitrogen in a slow release form and a smaller portion as unreacted urea which is soluble and therefore available for immediate absorption. By utilizing a nitrogen releasing ratio of approximately 4:1, tests indicate that the breakdown or decomposition of ureaformaldehyde to form soluble nitrogen salts occurs over a period of several years under average soil and moisture conditions. In fact, over a period of the first year, approximately 60% of the insoluble ureaformaldehyde may be decomposed and after several years, amounts of up to 10% of the original nitrogen may still be available for ion release for plant absorption. Therefore, this use of ureaformaldehyde enables the long-term availability of nitrogen by a one-time fertilization process while simultaneously reducing plant burn due to an overly concentrated source of nitrogen salts.

It should be noted that if the ratio of slow to fast release nitrogen is approximately 4:1, the amount of nitrogen immediately available for plant absorption is decreased and the percentage of residual nitrogen release over a 2 year period, as indicated above, is increased and the burn potential further decreased.

Likewise, a slow to fast release nitrogen ratio of 1:1 decreases the effective residual organic material available to provide for long-term nitrogen supplies but makes an increased amount of nitrogen available for immediate plant absorption. However, the concentration of available nitrogen salts is significantly increased and thus the possibility of plant or root burn is more likely. This, again, is particularly true in high analysis fertilizers wherein a substantial amount of nitrogen nutrient sources are available.

To effectively utilize ureaformaldehyde in conventional fertilizer spraying and subsurface injection apparatus, it is also preferable that it be used as a fine powder. The ureaformaldehyde particles should be small enough to pass a standard 40-mesh sieve; however, in accordance with certain embodiments, it is preferred that the major portion of such particles pass a 150-mesh sieve with many passing a 200-mesh sieve, and thus be of a consistency of a fine talc or hydrated lime. The particle size is desirable to permit the insoluble nitrogen sources to pass freely through conventional spray and injection apparatus when suspended in water. Moreover, this particle size is desirable to disperse readily in soil via hydraulic injection.

As previously discussed, to provide a high analysis fertilizer formulation having immediately available inorganic nutrients, the synthetic organic nitrogen releasing material or compound is blended with various inorganic compounds to form fertilizer compositions in which the total percent of the nitrogen is equal to or exceeds 30% and the total percent of the nitrogen, and potassium nutrients is at least 40% of the overall fertilizer weight.

Ideally, the amounts, ratio, and types of nutrient ions to be applied should be based not only on an individual or species of plant requirements, but also on the presence of nutrients already in the soil. The nutrient compositions of a soil may be determined by various tests, however, it is not always economically feasible to have such tests made for every fertilizer application nor are such testing methods readily available to all consumers. Therefore, it is preferable to supply a fertilizer composition which is formulated to supply nutrients in the proper amounts and in the proper ratios for the plant itself. Further, if the fertilizer is made to contain low salt index salts or ions and/or slow release nutrients such as long chain ureaformaldehyde, the possibility of root or plant burn by an overfeeding is greatly reduced. That is, if various ions are already available in the soil, the addition of a fertilizer having a low salt index inorganic source of phosphorus and potassium, as well as a slow release nitrogen, will be less likely to cause plant damage than other formulations.

The ratio of the macro-nutrients, nitrogen, phosphorus and potassium for tree fertilization typically is in the range of about 3:1:1, respectively, based on nutrient uptake and utilization. In accordance with the present invention, the fertilizer contains very little, if any, phosphorus. The amount of fertilizer applied, however, may vary dependent upon the size and type of tree or upon the square foot area defined by the drip line of a particular tree as well as upon the composition of the fertilizer itself. Fertilizers having both the necessary amount of nutrients allow for the desired promotion of growth in spring and summer by providing readily available nitrogen and also make available an annual supply of the macro-nutrient potassium.

In accordance with certain embodiments of the invention, the desired fertilizer formulation may be prepared to meet one or more of the following criteria: First, the fertilizer should provide nutrients in the most advantageous or beneficial preparations to support plant growth and nourishment, which for trees is a ratio of nitrogen to potassium of approximately 3:1, respectively; second, the fertilizer should be blended using components or nutrient supplies of low burn characteristics; third, the particle size should permit both surface applications and subsurface injection; and fourth, the nitrogen nutrient source should include a significant percentage of slow release nitrogen which reduces burn potential, retards leaching, and provides for extended tree growth.

The fertilizer composition may contain a urea-formaldehyde nitrogen source having both slow and fast release nitrogen components in which the fast release nitrogen is available as a generally soluble unreacted or excess of urea and the slow release nitrogen is available as a generally insoluble long chain methylene urea. In accordance with one aspect of the invention, ureaformaldehyde granules are pulverized to at least 40 mesh. One method for pulverizing the granules to the desired size involves the use of an air hammer (hammer mill).

The advantage of a product produced in this manner is that the size of the insoluble nitrogen releasing components is such that they may pass through conventional sprayer or injection equipment as long as they are maintained in a liquid suspension and not allowed to settle after having been placed in suspension.

In order to provide sufficient nutrients in one application, the fertilizer may have a high analysis formulation with a low “burn” potential. Further, to decrease bulk weight and increase fluid applications, the fertilizer, in accordance with certain aspects of the invention, may be substantially free of fillers and binding agents. Therefore, a potassium source material may be combined with a slow to fast release ureaformaldehyde in powder form and blended together with from about 0.25 to 2.5% of a polyamino acid salt to form a homogeneous mixture. A resultant fertilizer analysis of about (30−0−10) may be achieved using 4 parts of a ureaformaldehyde (38−0−0), blended with 1 part of potassium sulfate (0−0−52) and a beneficial amount of a polyamino acid salt, such as potassium polyaspartate (0−0−10). The actual nutrient percentage of the final (30−0−10) composition is generally 40% (30+0+10) of the total weight. Deviations or limitations on this percentage are regulated by the agriculture laws of various political jurisdictions. In Ohio, the Ohio Fertilizer Law, Regulation AG-61-01.06 allows an analytical tolerance of 97%. Thus, the total nutrient value cannot be less than 97% of the 40% fertilizer formulation, or 38.8% nutrients. On an individual basis, the percentage of the total nitrogen or potassium may not vary more than 10% or below 2 percentage points below the guaranteed analysis, whichever is smaller. For instance, for the (30−0−10), the nitrogen may vary to 28%, as the 2 percentage points is less than 10% of 30 or 3%. However, a deviation of 2% would alter the total nutrients to a value less than the allowed 97% of total nutrients. For potassium, the percentage would be governed by the 10% deviation in the actual analysis which would be less than a 2% percentage point deviation in the analysis and therefore could be as low 9% for potassium expressed as K₂O.

Again, the ratio of slow to fast release nitrogen may be effectively varied in the final composition by selecting a formulation of ureaformaldehyde having varied ratios of methylene ureas to unreacted ureas.

In developing the aforementioned example, the nitrogen source is available as ureaformaldehyde (38−0−0) or 38% nitrogen per 100 lbs. (45.36 kgs) and 52% soluble potassium sulfate expressed as K₂O per 100 lbs. (45.36 kgs) of the blend. When adding the nitrogen and potassium sources, it is apparent that in order to achieve the approximate 3:1 ratio, 79 parts of the (38−0−0) of the ureaformaldehyde should be uniformly blended with 19.3-20 parts of the potassium sulfate and 1-1.7 parts of potassium polyaspartate to produce approximately (30−0−10) per 100 lbs. (45.36 kgs) of blended fertilizer.

Although this approximate 3:1 ratio reflected by the (30−0−10) blend is preferred, slight variations of the nutrients N and K can be made without significantly altering the percent of each ingredient per 100 lbs. (45.36 kgs) and thus could be acceptable when used for similar applications.

An example of a low phosphorus fertilizer composition could be prepared by blending 79# ureaform (38% N), 4.35# triple super phosphate (46% P₂O₅), 15.5# potassium sulfate (52% K₂O) and 1.15# potassium polyaspartate (10% K₂O equivalent) to produce a 30−2−8 analysis composition (total nutrient content 40%). This blend would also keep the salt index below 10.

In addition to the acceptable degree of variation in the ratio of nutrients in the composition, the commercially available sources of nitrogen or potassium compound may also vary. The potassium source in accordance with certain embodiments may be a commercially available grade of potassium sulfate. Other potential sources of potassium that may be used in preparing the fertilizer compositions include, but are not limited to, muriate of potash (KCl), potassium sulfates, potassium hydroxides, potassium nitrates, potassium carbonates and bicarbonates, potassium magnesium sulfates and mixtures thereof. Further the ureaformaldehyde source may also vary from the preferred (38−0−0) depending upon commercially available sources. Other sources of nitrogen may also be used including, but not limited to, calcium nitrate, ammonium sulfate, ammonium nitrate, other nitrates, other forms of nitrogen and mixtures thereof. However, using a different N or K source will affect the salt index of the finished product. Furthermore, in those compositions containing low levels of P, the P source will also affect the salt index of the finished product.

In view of the foregoing, it can be seen that by varying the ratio of the nitrogen releasing source to the potassium between 2 to 5:1 respectively, and dependent upon the nitrogen and potassium source, various high analysis fertilizers may be blended to have a resultant nutrient percentage per 100 lbs. of weight in the range of approximately 25 to 32% nitrogen; 12 to 5% potassium and 0.25 to 2.5% polyamino acid salt. The resultant fertilizers, and especially those utilizing a 3 to 5:1 ratio of nitrogen releasing component to potassium, respectively, are particularly suitable for application to trees to provide the necessary nutrient value without causing root burn or otherwise adversely affecting the acidity of the soil surrounding the plant root system.

As discussed above, in order to facilitate the dispensing of the fertilizer product when used in a conventional sprayer or injector, it is desirable in certain embodiments that the organic material pass an 40-mesh sieve as the insoluble portions thereof will be suspended in a liquid solution when mixed with water for use. Because the potassium source and polyamino acid salt may be soluble and will therefore form a liquid when mixed with water, there need not be any specific size requirement with regard thereto; although a generally fine to granular size is preferred to insure a more homogeneous mixture. Nonetheless, the potassium source granules are preferably compatible in weight and size with powdered ureaformaldehyde in order to blend properly and remain homogeneous during shipping and handling.

Blending of the organic synthetic material and the inorganic material is complicated by the fact that ureaformaldehyde of the size required tends to flow or separate from the larger inorganic material when mixed by fertilizer blending equipment. However, by utilizing a curved bladed rotary type bulk mixer which operates in much the same manner as a cement mixer, the potassium source material and ureaformaldehyde may be blended in a homogeneous mixture using the above compound ratios. Further, the resultant fertilizer blend remained thoroughly mixed even after shipping and handling.

Amino acid salts may be extremely hygroscopic, which can cause problems in a dry-blending process. It has been found that the amino acid biopolymer salt can be blended with the remaining components of the fertilizer compositions described herein to protect the amino acid salt from moisture. Therefore, in accordance with one aspect of the invention, a preblend can be prepared comprising the polyamino acid salt and a portion of the remaining formulation. In particular, the polyamino acid salt can be blended with powdered ureaformaldehyde to produce a preblend that can be used in subsequent compounding operations.

In use, the high analysis fertilizer compositions of ureaformaldehyde, potassium and a polyamino acid salt may be mixed as described above and shipped to various supply outlets and/or potential users in dry form, thus simplifying product handling and storage as well as reducing the shipping weight. When it is desired to use the product, it can be mixed with varying quantities of water depending upon the type of application. Fertilizer strengths which are equivalent to six pounds of nitrogen to each thousand square feet have been safely applied to lawn areas and trees without causing any plant or root burn.

Further, due to the fact that the insoluble ureaformaldehyde particles which are suspended in solution when the fertilizer is mixed with water are so small, the fertilizer may be applied to surface or subsurface areas utilizing sprayers and pressure or hydraulic injection equipment without clogging equipment valves and nozzles.

While representative of the present invention, the following examples are not intended to limit the scope of the invention in any way.

### EXAMPLES

### Example 1

2-yr-old sycamore trees were grown in 15 gallon containers to capture and evaluate the entire root system. The trees were planted and treated in May and the plants were evaluated on November 14 of the same year. The FIGURE demonstrates the dramatic and statistical significance of the treatment effects. Treatment 1 (T1) represents the shoot and root growth of a complete fertilizer 30−10−7 (with 1% by weight PPA) at an application rate of 2.25 pounds of Nitrogen per 1000 sq. ft. of root area. T5 is a 30−0−10 fertilizer (no P) without the potassium polyaspartate (PPA) and T3 is the same fertilizer with the potassium polyaspartate (both fertilizers contained the same nitrogen and potassium source applied at the 2.25#N/1000 sq. ft rate). T1 and T3 were evaluated as having statistically similar shoot and root growth but T5 (no PPA) had significantly less growth. Rates were also reduced to 1.5#N/1000 sq. ft in T6, T4 and T2 and the same relationship existed. T4 and T2 (with and without phosphorus but with PPA) had significantly more root and shoot growth than T6 (no P, no PPA). T7 is the control treatment (no fertilizer).

As these results indicate, potassium polyaspartate (PPA) compensates for the removal of phosphorus providing similar shoot and root growth compared to a complete fertilizer with the same nitrogen and potassium sources that also contains PPA. This is significant for tree culture particularly in riparian areas where supplemental phosphorus is problematic. It was also unexpected because of the critical nature of phosphorus for root growth and development and the fact that phosphorus in the soil is mostly fixed and unavailable for plant absorption. A preliminary foliar analysis of phosphorus indicated that there was no change in the phosphorus uptake when phosphorus was removed from the fertilizer, with or without PPA.

### Example 2

The research was repeated with pin oaks and a complete foliar analysis was conducted to determine specifically what nutrients were involved in the unexpected plant response when phosphorus was removed from fertilizer but PPA was included. The results are charted below:

TABLE 1
Foliar Analysis - Pin Oak Trees

| Treatment/ | | | | | | | | |
|---|---|---|---|---|---|---|---|---|
| Products | | | | | | | | |
| Rate N per | N | P | K | Ca | S | Fe | Mn | Zn |
| 1,000 ft² | (%) | (%) | (%) | (%) | (%) | ppm | ppm | ppm |
| T2 Arbor | 2.34 | 0.2 | 1.03 | 0.96 | 0.15* | 79 | 718 | 43 |
| Green Pro | | | | | | | | |
| 2.25#N | | | | | | | | |
| T5 UF: | 1.8* | 0.17 | .88* | 0.79 | 0.12* | 46 | 702 | 34 |
| 38-0-0 | | | | | | | | |
| 2.25#N; | | | | | | | | |
| K₂SO₄ | | | | | | | | |
| T6 UF; | 2.29 | 0.17 | 0.96 | 0.79 | 0.14* | 90 | 999 | 48 |
| 38-0-0 | | | | | | | | |
| 2.25#N; | | | | | | | | |
| K₂SO₄; | | | | | | | | |
| PPA | | | | | | | | |
| T10 Check | 1.77* | 0.12 | 0.7* | 0.82 | 0.11* | 89 | 1490* | 24* |
| Recom- | 2.0 | 0.1 | 0.9 | 0.4 | 0.2 | 30 | 200 | 25 |
| mended | | | | | | | | |
| minimum | | | | | | | | |
| Recom- | 3.0 | 0.4 | 1.3 | 1.4 | 0.3 | 300 | 800 | 50 |
| mended | | | | | | | | |
| maximum | | | | | | | | |

*outside of the normal recommended nutrient range for pin oak trees

As was determined with the phosphorus foliar analysis of sycamore trees in the previous experiment, there was no significant change in phosphorus uptake of pin oak trees when phosphorus was removed from the fertilizer, with or without PPA, and the phosphorus remained within an acceptable range. However, both nitrogen and potassium fell below the acceptable levels when both phosphorus and PPA were removed. Trees treated without phosphorus but with PPA maintained acceptable nitrogen and potassium levels. Also note that the check trees (untreated) had insufficient nitrogen and potassium and that phosphorus was just within the acceptable range. Adding nitrogen and potassium without phosphorus (T5, T6) not only increased the uptake of nitrogen and potassium but also increased the uptake of phosphorus. However, without PPA (T5), the nitrogen and potassium were not increased to acceptable levels as occurred in the treatment with PPA (T6). Although not wishing to be bound by theory, it appears that it is the combined effect of nitrogen, potassium and PPA that is responsible for the dramatic and significant plant response and allows for the removal of phosphorus in environmentally sensitive areas such as riparian areas.

What is claimed is:

1. A fertilizer composition comprising a nitrogen source, a potassium source and potassium polyaspartate wherein said composition contains no more than 3% phosphorus.

2. The composition of claim 1 wherein said composition comprises from about 0.25% to about 2.5% by weight potassium polyaspartate.

3. The composition of claim 2 wherein said composition comprises from about 0.3% to about 1.0% by weight potassium polyaspartate.

4. The composition of claim 1 wherein the nitrogen source comprises ureaformaldehyde.

5. The composition of claim 4 wherein the ureaformaldehyde comprises generally water soluble and water insoluble nitrogen releasing nutrient compounds, said water insoluble compound being methylene urea and said water soluble compound being unreacted urea, the ratio of said water insoluble compound to said water soluble compound being approximately one to three parts of methylene urea to one part of unreacted urea.

6. The composition of claim 1 wherein the potassium source comprises potassium sulfate.

7. The composition of claim 1 wherein nitrogen and potassium are present generally in the ranges between about 25% to 32% for nitrogen and about 12% to 5% soluble potash expressed as K₂O based on weight.

8. The composition of claim 1 wherein the composition is phosphorus-free.

9. The composition of claim 1 wherein the composition comprises ureaformaldehyde and potassium sulfate.

10. A fertilizer composition comprising a nitrogen source, a potassium source and potassium polyaspartate, said nitrogen source being powdered ureaformaldehyde, said ureaformaldehyde having a ratio of between 1 to 3 parts of methylene urea to 1 part unreacted urea, said nitrogen source, potassium source and potassium polyaspartate being mixed so that the fertilizer composition is supplied with the nutrients N and K in an approximate ratio by weight of from about 2 to 5:1 respectively, wherein the fertilizer composition is a dry high analysis fertilizer composition containing no more than 3% phosphorus, wherein said fertilizer composition has a salt index of less than 10.

11. The composition of claim 10 wherein the composition is phosphorus-free.

12. The composition of claim 10 wherein said composition comprises from about 0.25 to about 2.5% by weight potassium polyaspartate.

13. The composition of claim 12 wherein said composition comprises from about 0.3% to about 1.0% potassium polyaspartate.

14. The composition of claim 10 wherein said potassium source comprises potassium sulfate.

15. A method for enhancing uptake of nutrients in woody perennials comprising:
a) providing a fertilizer composition comprising a nitrogen source, a potassium source and potassium polyaspartate wherein said composition contains no more than 3% phosphorus; and
b) treating a woody perennial with the fertilizer composition.

16. The method of claim 15 wherein said composition comprises from about 0.25% to about 2.5% by weight potassium polyaspartate.

17. The method of claim 16 wherein said composition comprises from about 0.3% to about 1.0% potassium polyaspartate.

18. The method of claim 15 wherein the nitrogen source and potassium source are present in amounts sufficient to provide a weight ratio of N and K of approximately 3-5:1.

19. The method of claim 15 wherein the nitrogen source comprises ureaformaldehyde.

20. The method of claim 19 wherein said step of providing a dry high analysis fertilizer composition comprises: preparing a preblend of ureaformaldehyde and potassium polyaspartate.

21. The method of claim 15 wherein the potassium source comprises potassium sulfate.

22. The method of claim 15 wherein the fertilizer composition is substantially phosphorus-free.
